(19) United States
(12) Patent Application Publication
(10) Pub. No.: US 2013/0126094 A1
(43) Pub. Date: May 23, 2013

(54) SUBSTRATE PROCESSING APPARATUS

(71) Applicant: SAMSUNG ELECTRONICS CO., LTD., Suwon-Si (KR)

(72) Inventors: Tae Ki HONG, Seoul (KR); Jin Hyuk CHOI, Suwon-si (KR); Sang Chul HAN, Suwon-si (KR)

(73) Assignee: SAMSUNG ELECTRONICS CO., LTD., Suwon-Si (KR)

(21) Appl. No.: 13/684,272

(22) Filed: Nov. 23, 2012

(30) Foreign Application Priority Data
Nov. 23, 2011 (KR) 10-2011-0122672

(51) Int. Cl. B05C 9/00

(52) U.S. Cl. CPC B05C 9/00
USPC 156/345.41; 156/345.1

(57) ABSTRACT

Disclosed is a substrate processing apparatus with an improved structure to reduce impurities in a chamber being attached to a substrate during processing of the substrate. The substrate processing apparatus generates plasma to process a substrate and includes a sidewall configured to receive the substrate on a receiving portion surrounded by the sidewall and a dielectric coupled to an upper part of the sidewall configured to hermetically seal the receiving portion, wherein the dielectric includes a shielding portion protruding from a bottom of the dielectric opposite the substrate to an inside of the receiving portion and a curved portion in a region at which the bottom and the shielding portion are connected to each other.

### CROSS-REFERENCE TO RELATED APPLICATION

This application claims the benefit of Korean Patent Application No. 2011-0122672, filed on Nov. 23, 2011 in the Korean Intellectual Property Office, the disclosure of which is incorporated herein in its entirety by reference.

### BACKGROUND

1. Field

Example embodiments relate to a substrate processing apparatus that processes a substrate using plasma.

2. Description of the Related Art

A substrate processing apparatus using plasma is an apparatus that generates plasma in a chamber, in which a substrate is received, using a microwave to process the substrate.

A conventional substrate processing apparatus generally includes the chamber, in which the substrate is received, the chamber being open at the top thereof, a dielectric to cover the open top of the chamber in order to hermetically seal the chamber, and a microwave generator to supply the microwave into the chamber. The microwave generated by the microwave generator penetrates the dielectric and reacts with gas supplied into the chamber to generate plasma. Substrate processing is then performed. For example, an oxide film is formed on the substrate or the substrate is etched, using the generated plasma.

In a conventional substrate processing apparatus, however, a strong electromagnetic standing wave may be formed in the dielectric. High-energy plasma may be formed in a region at which the dielectric abuts the chamber supporting the dielectric due to a strong electric field. As a result, the region at which the dielectric abuts the chamber may be sputtered by the plasma, and therefore, impurities may be attached to the substrate. Also, quality of the plasma (for example, radical density, plasma density, temperature of electrons) varies around the region at which the dielectric abuts the chamber, and therefore, the substrate may be nonuniformly processed. This phenomenon becomes more serious when power is increased for high-speed processing.

### SUMMARY

Example embodiments of inventive concepts provide a substrate processing apparatus with an improved structure to reduce impurities in a chamber from being attached to a substrate during processing of the substrate.

Example embodiments of inventive concepts provide a substrate processing apparatus with an improved structure to uniformly process a substrate.

Additional example embodiments will be set forth in part in the description that follows and, in part, will be obvious from the description, or may be learned by practice of the invention.

In accordance with example embodiments, a substrate processing apparatus that generates plasma to process a substrate includes a sidewall configured to receive the substrate in a receiving portion surrounded by the sidewall and a dielectric coupled to an upper part of the sidewall configured to hermetically seal the receiving portion, wherein the dielectric includes a shielding portion protruding from a bottom of the dielectric opposite the substrate to an inside of the receiving portion and a curved portion in a region at which the bottom and the shielding portion are connected to each other.

The bottom may be partitioned by the shielding portion into a first surface located inside the shielding portion and a second surface located outside the shielding portion, the second surface being supported by the upper part of the sidewall, and a depth of the first surface and a depth of the second surface from an end surface of the shielding portion opposite the substrate may be equal to each other.

The curved portion may be in a region at which the first surface and an inner circumferential surface of the shielding portion are connected to each other.

The curved portion may have a radius of curvature of about 10 to about 30 mm.

The shielding portion may include an outer circumferential surface connected to the second surface at an outer circumference of the shielding portion and a connection surface connected between the inner circumferential surface and the outer circumferential surface thereof in parallel with the bottom, the connection surface having a width of about 20 to about 40 mm.

The outer circumferential surface of the shielding portion may be spaced apart from an inner circumferential surface of the sidewall by a desired distance and includes a gap, and the gap may have a width of about 1 to about 2.5 mm.

The shielding portion may have a protruding length of about 20 to about 50 mm. The substrate processing apparatus may include a microwave generator configured to generate a microwave and an antenna configured to disperse the microwave generated by the microwave generator, wherein the dielectric is configured to transmit the microwave dispersed by the antenna so that the microwave forms plasma in the receiving portion.

The shielding portion may include a connection surface connected between the inner circumferential surface and an outer circumferential surface thereof, the connection surface being parallel to the bottom of the dielectric.

The connection surface may have a width equivalent to about ½ to about ¾ of a wavelength of the microwave passing through the dielectric.

The sidewall may include a lower sidewall configured to receive a substrate in a receiving portion surrounded by the lower sidewall and an upper sidewall coupled to an upper part of the lower sidewall to surround the receiving portion together with the lower sidewall, the upper sidewall abutting the outside portion to support the dielectric.

The curved portion may have a radius of curvature of about 10 to about 30 mm.

An outer circumferential surface of the shielding portion may be spaced apart from an inner circumferential surface of the upper sidewall by a desired distance and includes a gap, and the gap may have a width of about 1 to about 2.5 mm.

An outer circumferential surface of the shielding portion may be perpendicular to the bottom of the dielectric, and the outer circumferential surface of the shielding portion may have a length of about 20 to about 50 mm.

A distance between the inner circumferential surface and an outer circumferential surface of the shielding portion may be gradually increased toward the bottom of the dielectric.

In accordance with another example embodiment, a substrate processing apparatus includes a chamber, in which a substrate is disposed, the chamber being open at an upper part thereof, and a dielectric coupled to an upper part of the chamber configured to hermetically seal the chamber, wherein the dielectric includes a shielding portion protruding from a bottom of the dielectric opposite the substrate to an inside of the chamber and a recess portion from a center of the shielding portion in the radial direction of the shielding portion, the recess portion having a depth equal to a protruding length of the shielding portion.

The recess portion may have a curved surface at an edge thereof, and the curved surface may have a radius of curvature of about 10 to about 30 mm.

In accordance with another example embodiment, a substrate processing apparatus that generates plasma to process a substrate includes a sidewall, the sidewall including a bottom portion and side portions, and a dielectric connected to the sidewall and configured to hermetically seal the top of the sidewall to form a hollow chamber, the dielectric including a shielding portion on the bottom of the dielectric, the shielding portion including a curved portion and a flat portion.

The curved portion may have a greater depth than the flat portion, forming a ridge facing the bottom portion of the sidewall.

A bottom of the dielectric may be partitioned by the curved portion into a first surface located inside the curved portion and a second surface located outside the curved portion, the second surface being supported by an upper part of the sidewall, and a depth of the first surface and a depth of the second surface are equal to each other.

### BRIEF DESCRIPTION OF THE DRAWINGS

These and/or other aspects of the invention will become apparent and more readily appreciated from the following description of some example embodiments, taken in conjunction with the accompanying drawings in which:

FIG. 1 is a perspective view showing the construction of a substrate processing apparatus according to an example embodiment;

FIG. 2 is a sectional view showing the construction of the substrate processing apparatus according to the example embodiment of FIG. 1;

FIG. 3 is an enlarged view showing portion ‘A’ in FIG. 2; and

FIG. 4 is a graph showing the density of plasma around a substrate processed by the substrate processing apparatus according to example embodiments.

### DETAILED DESCRIPTION

Reference will now be made in detail to some example embodiments, examples of which are illustrated in the accompanying drawings, wherein like reference numerals refer to like elements throughout.

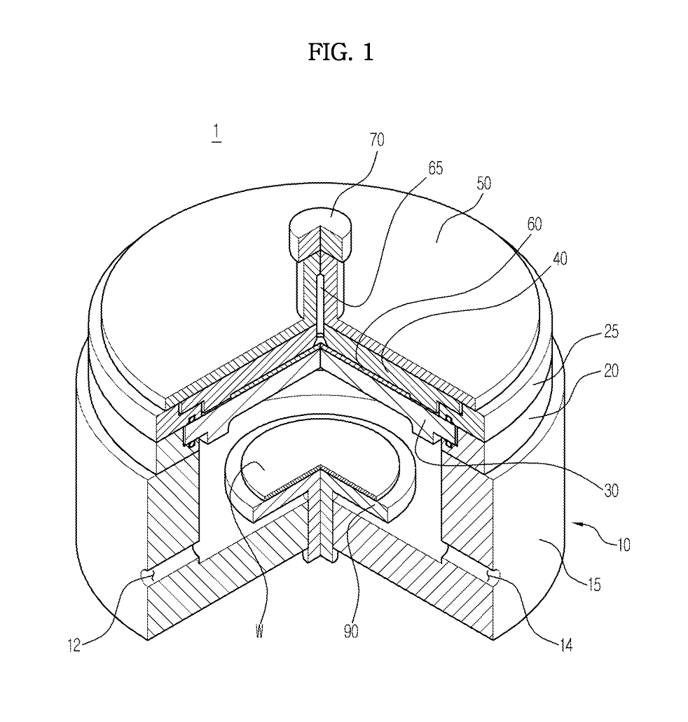

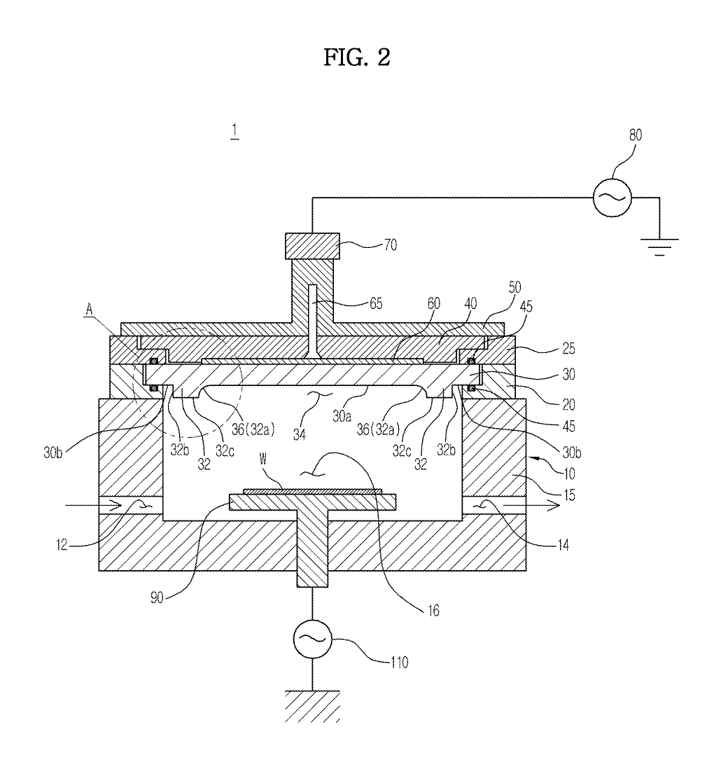

FIG. 1 is a perspective view showing the construction of a substrate processing apparatus according to an example embodiment, and FIG. 2 is a sectional view showing the construction of the substrate processing apparatus according to example embodiments.

As shown in FIGS. 1 and 2, a substrate processing apparatus 1 includes a cylindrical chamber 10 open at the top thereof, a dielectric 30 to cover the open top of the chamber 10 in order to hermetically seal the chamber 10, a disc-shaped antenna 60 on the dielectric 30, antenna covers 40 and 50 to cover the antenna 60, and a microwave generator 80 to supply a microwave to the antenna 60.

The chamber 10 may be aluminum or an aluminum alloy. The chamber 10 includes a lower sidewall 15 surrounding a receiving portion 16 to receive a substrate W and an upper sidewall 20 on the lower sidewall 15 to support the dielectric 30. At the lower part of the receiving portion 16 is a susceptor 90 to support the substrate W being processed. At the susceptor 90 may be mounted a heater (not shown) to control processing temperature. A biased high frequency from an AC power supply 110 outside the chamber 10 is supplied to the susceptor 90. The lower sidewall 15, the upper sidewall 20, and the susceptor 90 may be aluminum.

At the side of the lower sidewall 15 is a gas inlet port 12, such as a nozzle, to supply a processing gas from a processing gas supply source (not shown) into the chamber 10 and a gas outlet port 14 to discharge the processing gas from the chamber 10. A gas containing argon (Ar), oxygen (O₂), and hydrogen (H₂) may be used as the processing gas. Krypton (Kr), xenon (Xe), or helium (He) may be used instead of argon (Ar).

Between the upper sidewall 20 and the dielectric 30 supported by the upper sidewall 20 and between the dielectric 30 and a support portion 25 pressing against the dielectric 30 at the upper edge of the dielectric 30 are O-rings 45 to completely hermetically seal the chamber 10.

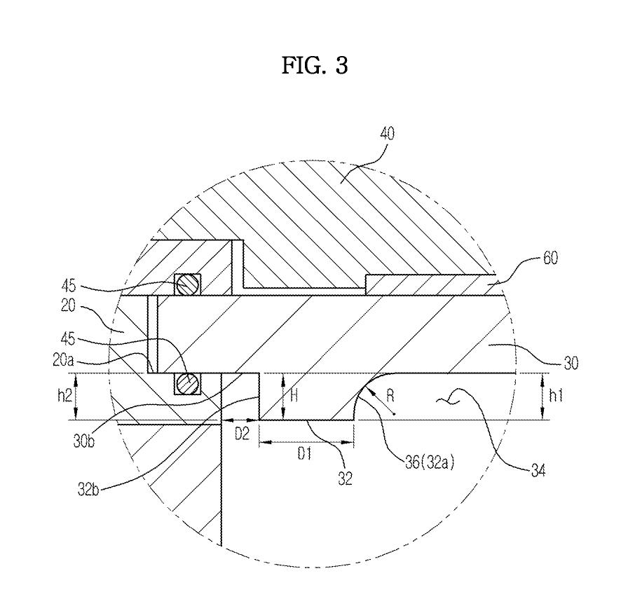

The edge of the dielectric 30, in the shape of a disc, is supported by a support surface 20a (shown in FIG. 3) of the upper sidewall 20. A microwave, transmitted through the antenna 60, penetrates the dielectric 30 and is supplied into the chamber 10. The dielectric 30 may be a material that a microwave penetrates, such as quartz, sapphire, ceramic, and crystallized quartz.

The antenna 60 is on the dielectric 30. The antenna 60 constitutes a thin disc exhibiting conductivity, such as copper coated with Ag or A. On the disc is a plurality of slits (not shown) arranged in a spiral shape or a concentric shape so that a microwave is dispersed and passes through the slits.

A coaxial waveguide 65 is embedded in the antenna covers 40 and 50. The coaxial waveguide 65 is connected to the antenna 60 to guide a microwave generated by the microwave generator 80 to the antenna 60.

A microwave, for example a microwave of 2.45 GHz, generated by the microwave generator 80, passes through a load matcher 70, the coaxial waveguide 65, and the antenna 60 and is transmitted to the dielectric 30. Using energy from the microwave, an electric field is formed at the bottom of the dielectric 30 to plasmarize the processing gas supplied into the chamber 10 through the gas inlet port 12 so that desired plasma processing is performed with respect to the substrate W on the susceptor 90 (for example, a thin oxide film is formed on the substrate W).Hereinafter, the shape of the dielectric 30 configured to uniformly distribute the plasma generated in the receiving portion 16 and to reduce arcing or sputtering will be described in detail.

FIG. 3 is an enlarged view showing portion ‘A’ in FIG. 2.

As shown in FIG. 3, the dielectric 30 serves as a transmitter to transmit a microwave into the chamber 10 via the antenna 60. The dielectric 30 includes a shielding portion 32 protruding from the bottom of the dielectric 30 opposite the substrate W to the inside of the receiving portion 16 defined in the chamber 10 by a desired length and a recess portion 34 from the center of the shielding portion 32 in the radial direction of the shielding portion 32. The recess portion 34 may be in the shape of a circle, but is not limited thereto. For example, the recess portion 34 may assume any geometric shape.

The shielding portion 32 includes an inner circumferential surface 32a forming the inner circumference thereof, an outer circumferential surface 32b forming the outer circumference thereof, and a connection surface 32c connected between the inner circumferential surface 32a and the outer circumferential surface 32b. The inner circumferential surface 32a may be regarded as the edge of the recess portion 34.

The connection surface 32c is parallel to the bottom of the dielectric 30. The connection surface 32c may have a width D1 equivalent to about ½ to about ¾ of the wavelength of a microwave penetrating the shielding portion 32 or about 20 to about 40 mm. If the width of the connection surface 32c is less than half, for example ½, of the wavelength of the microwave, arcing may occur around the connection surface 32c due to the microwave transmitted through the connection surface 32c. If the width of the connection surface 32c is greater than ¾ of the wavelength of the microwave, the microwave is concentrated around the connection surface 32c with the result that the density of plasma at the connection surface 32c may be greater than that in the remaining portion.

The bottom of the dielectric 30 is partitioned by the shielding portion 32 into a first surface 30a located inside the shielding portion 32 and a second surface 30b located outside the shielding portion 32. The second surface 30b is supported by the support surface 20a of the upper sidewall 20.

The depth h1 of the first surface 30a and the depth h2 of the second surface 30b from the end surface, for example the connection surface 32c, of the shielding portion 32 opposite the substrate W are equal to each other. Consequently, concentration of the microwave, reflected by the edge of the shielding portion 32, at a specific point around an interface between the shielding portion 32 and the receiving portion 16 adjacent to the shielding portion 32, for example, an interface at which different media are adjacent to each other, is reduced, thereby reducing generation of a high electric field or high-density plasma around the interface.

The depth h1 of the first surface 30a from the connection surface 32c is equal to the depth of the recess portion 34, and the depth h2 of the second surface 30b from the connection surface 32c is equal to the length H of the shielding portion 32 protruding from the bottom of the dielectric 30. Consequently, the depth of the recess portion 34 may be equal to the length H of the shielding portion 32 protruding from the bottom of the dielectric 30.

A curved portion 36 is formed in a region at which the first surface 30a and the inner circumferential surface 32a of the shielding portion 32 join to each other, for example at the edge of the recess portion 34. As an example, the curved portion 36 may form a ridge on the bottom of the shielding portion 32 facing the bottom of the chamber 10. As discussed above with regard to the recess portion 34, the curved portion 36 may be in the shape of a circle, but is not limited thereto. For example, the curved portion 36 may assume any geometric shape.

The curved portion 36 reduces concentration of a microwave in the vicinity thereof to reduce generation of a high electric field or high-density plasma around the curved portion 36. Also, the curved portion 36 prevents electrons or radicals generated by the plasma in the receiving portion 16 from moving or diffusing to the edge of the shielding portion 32, for example the upper sidewall 15 or the lower sidewall 16, to increase the density and uniformity of particles around the substrate W so that an oxide film of a uniform thickness is formed on the substrate W.

The intensity of the electric field or the density of the plasma generated around the curved portion 36 may be controlled by curvature of the curved portion 36. To reduce the occurrence of arcing around the curved portion 36 and to form an oxide film of a uniform thickness on the substrate W, the curved portion 36 may have a curvature R of about 10 to about 30 mm. The outer circumferential surface 32b of the shielding portion 32 is spaced apart from the inner circumferential surface of the upper sidewall 20 by a desired distance to form a gap D2. The gap D2 prevents a strong electric field from being generated between the outer circumferential surface 32b of the shielding portion 32 and the inner circumferential surface of the upper sidewall 20, thereby reducing the edge of the shielding portion 32 from being damaged by arcing or the upper sidewall 20 around the edge of the shielding portion 32 from being damaged by sputtering.

The intensity of the electric field generated between the outer circumferential surface 32b of the shielding portion 32 and the inner circumferential surface of the upper sidewall 20 or the density of the plasma generated between the outer circumferential surface 32b of the shielding portion 32 and the inner circumferential surface of the upper sidewall 20 may be controlled by the length of the gap D2. To effectively reduce arcing of the edge of the shielding portion 32 and sputtering of the upper sidewall 20 around the edge of the shielding portion 32, the gap D2 has a length of about 1 to about 2.5 mm.

Also, the outer circumferential surface 32b and the connection surface 32c of the shielding portion 32 reduce particles, such as ions and radicals generated by sputtering in a region at which the edge of the shield portion 32 contacts the upper sidewall 20 or in the vicinity thereof, from reaching the substrate W. The length of the outer circumferential surface 32b of the shielding portion 32 is equal to the length H of the shielding portion 32 protruding from the bottom of the dielectric 30. To effectively reduce particles, such as ions and radicals generated by sputtering in a region at which the edge of the shield portion 32 contacts the upper sidewall 20 or in the vicinity thereof, from reaching the substrate W, the outer circumferential surface 32b of the shielding portion 32 may have a length of about 20 to about 50 mm.

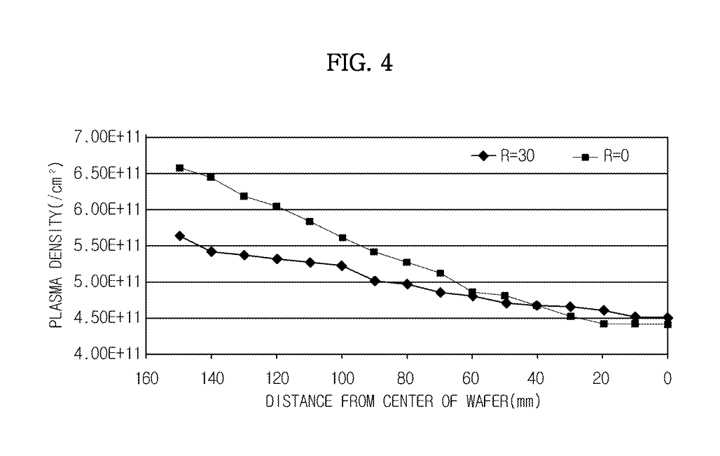

FIG. 4 is a graph showing the density of plasma around the substrate processed by the substrate processing apparatus according to example embodiments.

The graph of FIG. 4 shows a comparison of the density of plasma generated around the substrate W between a case in which the protruding length H of the shielding portion 32 is 30 mm, the width D1 of the connection surface 32c is 20 mm, the length of the gap D2 is 2 mm, and a curved portion 36 having a radius of curvature of 30 mm is provided and another case in which the protruding length H of the shielding portion 32 is 30 mm, the width D1 of the connection surface 32c is 20 mm, the length of the gap D2 is 2 mm, and no curved portion 36 is provided.

As shown in the graph, the density of plasma at the central part of the substrate W in the case in which the curved portion 36 is provided is hardly different from that in the case in which the curved portion 36 is not provided. The density of plasma toward the edge of the substrate W in the case in which the curved portion 36 is provided is increasingly different from that in the case in which the curved portion 36 is not provided. The density of plasma around the substrate W in the case in which the curved portion 36 is more uniform than the density of plasma in the case in which the curved portion 36 is not provided. These results prove that as previously described, the density of plasma around the substrate W is uniformly controlled by the shielding portion 32 located above the edge of the substrate W.

As is apparent from the above description, in the substrate processing apparatus according to example embodiments, arcing of the dielectric or sputtering around the region at which the dielectric abuts the chamber by plasma is reduced, thereby reducing the amount of impurities attached to the substrate.

Also, the density of plasma generated in the chamber is uniform, thereby uniformly processing the substrate.

Although a few example embodiments have been shown and described, it would be appreciated by those skilled in the art that changes may be made in these example embodiments without departing from the principles and spirit of the invention, the scope of which is defined in the claims and their equivalents.

What is claimed is:

1. A substrate processing apparatus that generates plasma to process a substrate, comprising:
a sidewall configured to receive the substrate in a receiving portion surrounded by the sidewall; and
a dielectric coupled to an upper part of the sidewall configured to hermetically seal the receiving portion, wherein the dielectric includes,
a shielding portion protruding from a bottom of the dielectric opposite the substrate to an inside of the receiving portion; and
a curved portion in a region at which the bottom and the shielding portion are connected to each other.

2. The substrate processing apparatus according to claim 1, wherein
the bottom is partitioned by the shielding portion into a first surface located inside the shielding portion and a second surface located outside the shielding portion, the second surface being supported by the upper part of the sidewall, and
a depth of the first surface and a depth of the second surface from an end surface of the shielding portion opposite the substrate are equal to each other.

3. The substrate processing apparatus according to claim 2, wherein the curved portion is in a region at which the first surface and an inner circumferential surface of the shielding portion are connected to each other.

4. The substrate processing apparatus according to claim 3, wherein the curved portion has a radius of curvature of about 10 to about 30 mm.

5. The substrate processing apparatus according to claim 3, wherein the shielding portion comprises:
an outer circumferential surface connected to the second surface at an outer circumference of the shielding portion; and
a connection surface connected between the inner circumferential surface and the outer circumferential surface thereof in parallel with the bottom,
the connection surface having a width of about 20 to about 40 mm.

6. The substrate processing apparatus according to claim 5, wherein
the outer circumferential surface of the shielding portion is spaced apart from an inner circumferential surface of the sidewall by a desired distance and includes a gap, and
the gap has a width of about 1 to 2.5 mm.

7. The substrate processing apparatus according to claim 1, wherein the shielding portion has a protruding length of about 20 to about 50 mm.

8. The substrate processing apparatus according to claim 1, further comprising:
a microwave generator configured to generate a microwave; and
an antenna configured to disperse the microwave generated by the microwave generator;
wherein the dielectric is configured to transmit the microwave dispersed by the antenna so that the microwave forms plasma in the receiving portion.

9. The substrate processing apparatus according to claim 8, wherein the shielding portion includes a connection surface connected between the inner circumferential surface and an outer circumferential surface thereof, the connection surface being parallel to the bottom of the dielectric.

10. The substrate processing apparatus according to claim 9, wherein the connection surface has a width equivalent to about ½ to about ¾ of a wavelength of the microwave passing through the dielectric.

11. The substrate processing apparatus according to claim 8, wherein the sidewall further comprises:
a lower sidewall configured to receive a substrate on a receiving portion surrounded by the lower sidewall; and
an upper sidewall coupled to an upper part of the lower sidewall surround the receiving portion together with the lower sidewall, the upper sidewall abutting the outside portion to support the dielectric.

12. The substrate processing apparatus according to claim 8, wherein the curved portion has a radius of curvature of about 10 to about 30 mm.

13. The substrate processing apparatus according to claim 11, wherein
an outer circumferential surface of the shielding portion is spaced apart from an inner circumferential surface of the upper sidewall by a desired distance and includes a gap, and
the gap has a width of about 1 to about 2.5 mm.

14. The substrate processing apparatus according to claim 8, wherein an outer circumferential surface of the shielding portion is perpendicular to the bottom of the dielectric, and the outer circumferential surface of the shielding portion has a length of about 20 to about 50 mm.

15. The substrate processing apparatus according to claim 8, wherein a distance between the inner circumferential surface and an outer circumferential surface of the shielding portion is gradually increased toward the bottom of the dielectric.

16. A substrate processing apparatus including a chamber, in which a substrate is disposed, the chamber being open at an upper part thereof, and a dielectric coupled to an upper part of the chamber configured to hermetically seal the chamber, wherein the dielectric includes
a shielding portion protruding from a bottom of the dielectric opposite the substrate to an inside of the chamber
the shielding portion recessed from a center of the shielding portion in the radial direction of the shielding portion, the recessed portion of the shielding portion having a depth equal to a protruding length of the shielding portion.

17. The substrate processing apparatus according to claim 16, wherein the recessed portion of the shielding portion has a curved surface at an edge thereof, and the curved surface has a radius of curvature of about 10 to about 30 mm.

18. A substrate processing apparatus that generates plasma to process a substrate, comprising:
a sidewall, the sidewall including a bottom portion and side portions; and
a dielectric connected to the sidewall and configured to hermetically seal the top of the sidewall to form a hollow chamber, the dielectric including a shielding portion on the bottom of the dielectric, the shielding portion including a curved portion and a flat portion.

19. The substrate processing apparatus of claim 18, wherein the curved portion has a greater depth than the flat portion, forming a ridge facing the bottom portion of the sidewall.

20. The substrate processing apparatus of claim 18, wherein a bottom of the dielectric is partitioned by the curved portion into a first surface located inside the curved portion and a second surface located outside the curved portion, the second surface being supported by an upper part of the sidewall, and
a depth of the first surface and a depth of the second surface are equal to each other.
